(19) United States
(12) Patent Application Publication
(10) Pub. No.: US 2024/0303477 A1
(43) Pub. Date: Sep. 12, 2024

(54) Batch Softmax For 0-Label And Multilabel Classification

(71) Applicant: QUALCOMM Technologies, Inc., San Diego, CA (US)

(72) Inventors: Shuai LIAO, Amsterdam (NL); Efstratios GAVVES, Amsterdam (NL); Cornelis Gerardus Maria SNOEK, Volendam (NL)

(21) Appl. No.: 17/754,906

(22) PCT Filed: Nov. 16, 2020
(86) PCT No.: PCT/US2020/060797

§ 371 Date: Apr. 15, 2022

(30) Foreign Application Priority Data
Nov. 15, 2019 (GR) 20190100516

(51) Int. Cl. G06N 3/08

(52) U.S. Cl. CPC G06N 3/08

(57) ABSTRACT

Embodiments include methods, and processing devices for implementing the methods. Various embodiments may include calculating a batch softmax normalization factor using a plurality of logit values from a plurality of logits of a layer of a neural network, normalizing the plurality of logit values using the batch softmax normalization factor, and mapping each of the normalized plurality of logit values to one of a plurality of manifolds in a coordinate space. In some embodiments, each of the plurality of manifolds represents a number of labels to which a logit can be classified. In some embodiments, at least one of the plurality of manifolds represents a number of labels other than one label.

### RELATED APPLICATIONS

This application claims the benefit of priority to Greek Application No. 20190100516 entitled “Batch Softmax For 0-Label And Multilabel Classification” filed 15 Nov. 2019, the entire contents of which are incorporated herein by reference.

### BACKGROUND

In a live application, a model is always expected to have a high prediction accuracy and provide reliable confidence scores. Scores from the softmax classifier with probabilistic interpretation are the main source to access model confidence. However, softmax-based confidence scores have notable drawbacks. The softmax-based confidence score might be not trustworthy. In particular, it is observed that deep neural networks tend to be overconfident on in-distribution data and yield high confidence on out-of-distribution data (data that is far away from the training data). It is also known that deep neural networks are vulnerable to adversarial attacks in which only a slight change to correctly classified examples causes misclassification. Further, softmax is designed to model the categorical distribution of single-label classification problem where the output space is a probability simplex. But the categorical assumption doesn't hold for 0-label problems or N-label problems, where N>1.

### SUMMARY

Various disclosed aspects may include apparatuses and methods. Various aspects may include generating a batch softmax normalization factor using a plurality of logit values from a plurality of logits of a layer of a neural network, normalizing the plurality of logit values using the batch softmax normalization factor, and mapping each of the normalized plurality of logit values to one of a plurality of manifolds in a coordinate space. In some aspects, each of the plurality of manifolds represents a number of labels to which a logit can be classified, and at least one of the plurality of manifolds represents a number of labels other than one label.

Some aspects may further include calculating a loss value of the normalized plurality of logit values compared to a ground truth number of labels to which the logits are classified.

Some aspects may further include training the neural network using the loss value to generate logits that are mapped to an appropriate manifold in the coordinate space prior to normalization of the logits. In some aspects, the logits are mapped based on the number of labels to which the logit can be classified.

In some aspects, generating the batch softmax normalization factor may include constraining the batch softmax normalization factor such that a sum of prediction values resulting from normalizing the plurality of logit values using data point dependent normalization constants equals a sum of all labels for the plurality of logit values.

In some aspects, generating the batch softmax normalization factor may include identifying maximum logit values for the plurality of logits, and removing the maximum logit values. In some aspects, the plurality of logit values comprises logit values remaining after removing the maximum logit values.

In some aspects, generating the batch softmax normalization factor may include constraining the batch softmax normalization factor such that an exponential function of any logit value of the plurality of logit values is less than or equal to a data point dependent normalization constant.

In some aspects, the plurality of manifolds may include N+1 manifolds for N labels, in which a first manifold of the plurality of manifolds represents zero labels, a second manifold of the plurality of manifolds represents one label, and a third manifold of the plurality of manifolds represents N labels.

In some aspects, the first manifold may be an origin point of the coordinate space, the second manifold may be a simplex in the coordinate space, the third manifold may be a point of the coordinate space opposite the origin point, and generating the batch softmax normalization factor using the plurality of logit values from the plurality of logits of the layer of the neural network may include generating the batch softmax normalization factor using the plurality of logit values from the plurality of logits of a last hidden layer of the neural network.

Various aspects include computing devices having a processor configured to perform operations of any of the methods summarized above. Various aspects include computing devices having means for performing functions of any of the methods summarized above. Various aspects include a non-transitory, processor-readable medium on which are stored processor-executable instructions configured to cause a processor to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multicore processor suitable for implementing an embodiment.

FIG. 3 is a graph diagram illustrating an example of softmax.

FIG. 4 is graph diagram illustrating an example of softmax confidence.

FIG. 5 is a graph diagram illustrating an example of softmax coefficients.

FIG. 6 is a component flow block diagram illustrating an example neural network suitable for implementing an embodiment.

FIG. 7 is process flow diagram illustrating an example of batch softmax suitable for implementing an embodiment.

FIG. 8 is a graph diagram illustrating an example of batch softmax suitable for implementing an embodiment.

FIG. 9 is a graph diagram illustrating an example of batch softmax confidence suitable for implementing an embodiment.

FIG. 10 is a graph diagram illustrating an example of batch softmax factors suitable for implementing an embodiment.

FIG. 11 is a process flow diagram illustrating a method for implementing batch softmax according to some embodiments.

FIG. 12 is a process flow diagram illustrating a method for generating a batch softmax normalization factor according to some embodiments.

FIG. 13 is a component block diagram illustrating an example mobile computing device suitable for use with the various embodiments.

FIG. 14 is a component block diagram illustrating an example mobile computing device suitable for use with the various embodiments.

FIG. 15 is a component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and devices implementing such methods for batch softmax for 0-label and multilabel classification. The devices and methods for batch softmax for 0-label and multilabel classification may include generating a batch softmax normalization factor based on a batch of logits resulting from implementation of a neural network for an input data set. Some embodiments may include mapping batch softmax normalized logits to multiple manifolds in a coordinate space. Various embodiments are also described in a draft of the article “Batch Softmax for Out-of-distribution and Multi-label Classification,” which is attached hereto as an appendix and is part of this disclosure.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

The terms “label”, “class”, and “classification” herein are used interchangeably. The terms “prediction” and “probability” herein are used interchangeably.

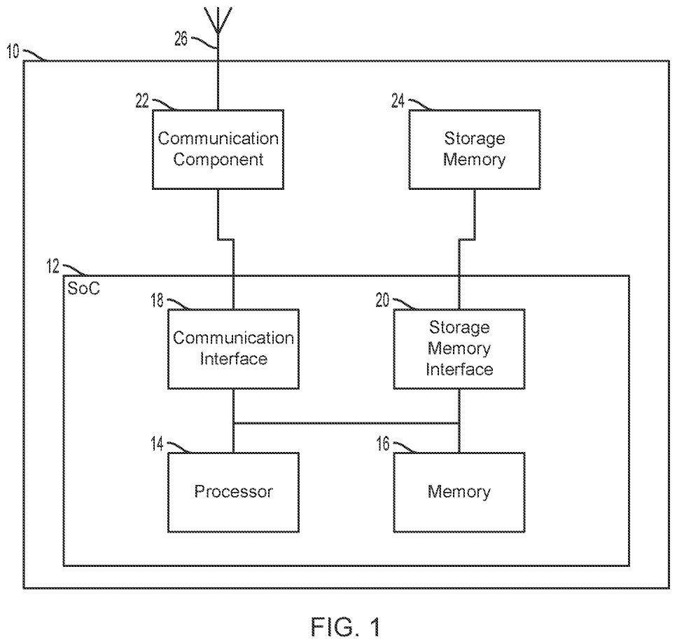

FIG. 1 illustrates a system including a computing device 10 suitable for use with the various embodiments. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

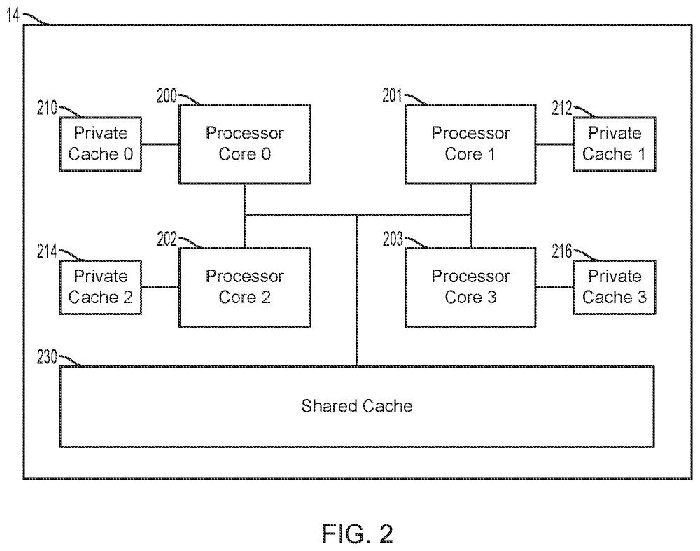

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory.

These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various embodiments. The computing device 10 may not be limited to one of each of the components, and multiple instances of each component may be included in various configurations of the computing device 10.

FIG. 2 illustrates a multicore processor suitable for implementing an embodiment. The multicore processor 14 may include multiple processor types, including, for example, a central processing unit, a graphics processing unit, and/or a digital processing unit. The multicore processor 14 may also include a custom hardware accelerator, which may include custom processing hardware and/or general purpose hardware configured to implement a specialized set of functions.

The multicore processor may have a plurality of homogeneous or heterogeneous processor cores 200, 201, 202, 203. A homogeneous multicore processor may include a plurality of homogeneous processor cores. The processor cores 200, 201, 202, 203 may be homogeneous in that, the processor cores 200, 201, 202, 203 of the multicore processor 14 may be configured for the same purpose and have the same or similar performance characteristics. For example, the multicore processor 14 may be a general purpose processor, and the processor cores 200, 201, 202, 203 may be homogeneous general purpose processor cores. The multicore processor 14 may be a graphics processing unit or a digital signal processor, and the processor cores 200, 201, 202, 203 may be homogeneous graphics processor cores or digital signal processor cores, respectively. The multicore processor 14 may be a custom hardware accelerator with homogeneous processor cores 200, 201, 202, 203. For ease of reference, the terms “custom hardware accelerator,” “processor,” and “processor core” may be used interchangeably herein.

A heterogeneous multicore processor may include a plurality of heterogeneous processor cores. The processor cores 200, 201, 202, 203 may be heterogeneous in that the processor cores 200, 201, 202, 203 of the multicore processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, an SoC (for example, SoC 12 of FIG. 1) may include any number of homogeneous or heterogeneous multicore processors 14. In various embodiments, not all off the processor cores 200, 201, 202, 203 need to be heterogeneous processor cores, as a heterogeneous multicore processor may include any combination of processor cores 200, 201, 202, 203 including at least one heterogeneous processor core.

Each of the processor cores 200, 201, 202, 203 of a multicore processor 14 may be designated a private cache 210, 212, 214, 216 that may be dedicated for read and/or write access by a designated processor core 200, 201, 202, 203. The private cache 210, 212, 214, 216 may store data and/or instructions, and make the stored data and/or instructions available to the processor cores 200, 201, 202, 203, to which the private cache 210, 212, 214, 216 is dedicated, for use in execution by the processor cores 200, 201, 202, 203. The private cache 210, 212, 214, 216 may include volatile memory as described herein with reference to memory 16 of FIG. 1.

The multicore processor 14 may further include a shared cache 230 that may be configured to for read and/or write access by the processor cores 200, 201, 202, 203. The private cache 210, 212, 214, 216 may store data and/or instructions, and make the stored data and/or instructions available to the processor cores 200, 201, 202, 203, for use in execution by the processor cores 200, 201, 202, 203. The shared cache 230 may also function as a buffer for data and/or instructions input to and/or output from the multicore processor 14. The shared cache 230 may include volatile memory as described herein with reference to memory 16 of FIG. 1.

In the example illustrated in FIG. 2, the multicore processor 14 includes four processor cores 200, 201, 202, 203 (i.e., processor core 0, processor core 1, processor core 2, and processor core 3). In the example, each processor core 200, 201, 202, 203 is designated a respective private cache 210, 212, 214, 216 (i.e., processor core 0 and private cache 0, processor core 1 and private cache 1, processor core 2 and private cache 2, and processor core 3 and private cache 3). For ease of explanation, the examples herein may refer to the four processor cores 200, 201, 202, 203 and the four private caches 210, 212, 214, 216 illustrated in FIG. 2. However, the four processor cores 200, 201, 202, 203 and the four private caches 210, 212, 214, 216 illustrated in FIG. 2 and described herein are merely provided as an example and in no way are meant to limit the various embodiments to a four-core processor system with four designated private caches. The computing device 10, the SoC 12, or the multicore processor 14 may individually or in combination include fewer or more than the four processor cores 200, 201, 202, 203 and private caches 210, 212, 214, 216 illustrated and described herein.

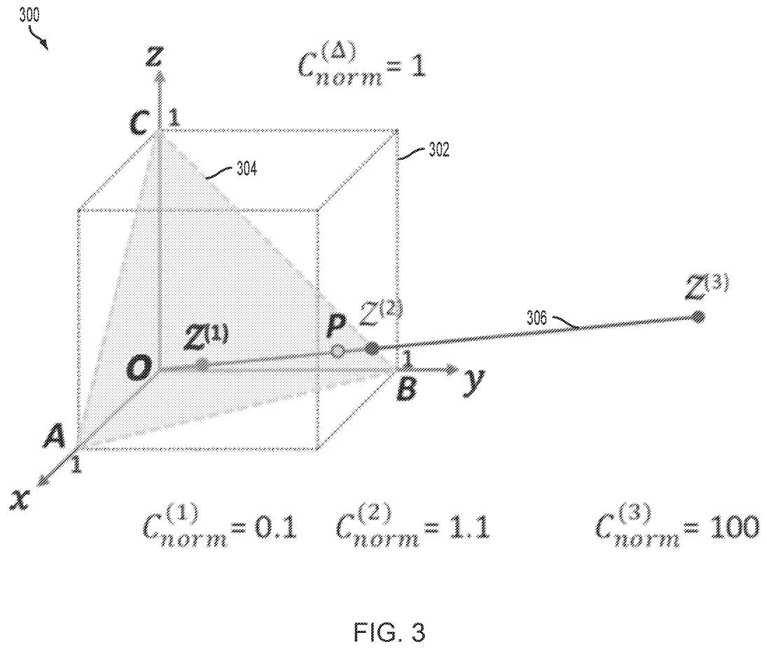

FIG. 3 illustrates an example of softmax. The softmax function may be used to approximate a categorical distribution of a neural network output as the following equation:

$${p}_{k} = \frac{{e}^{{z}_{k}}}{{\sum }_{i} {e}^{{z}_{i}}} \qquad ( eq . 1 )$$

where Z=[z₀, . . . , zₖ] is a logits embedding by a deep neural network for given input data “x”. The softmax function applies the exponential function and L1 normalization to the logits vector Z, which results in a probability vector P=[p₀, . . . , pₙ] representing a probability of each of the classes applying to each of the logits, i.e., pₖ=p(y=k|x). Generally, the probability scores may be used as model confidence scores for various purposes, such as thresholding in decision making or retrieving items in ranking.

The softmax function uses a data point dependent normalization constant (Cₙₒᵣₘ):

$${C}_{n o r m} = {\sum }_{i} {e}^{{z}_{i}} \qquad ( eq . 2 )$$

which is the divisor in the normalization function in eq. 1. The data point dependent Cₙₒᵣₘ may cause logits embedding ambiguity and cannot be applied to properly handle 0-label and N-label problems.

With the softmax function, multiple distinct logits embedding points, e.g., z₁, z₂, and z₃, may be projected at the same output point “P”. This may be referred to as the uncalibrated logits problem. This problem arises due to the fact that while the Cₙₒᵣₘ for each of the logits embedding points are different, they depend on a particular data sample of the given input. The graph 300 illustrates projections of the logits embedding points z₁, z₂, and z₃ onto a simplex 304 in a Euclidian space 302 at an output point P. The logits embedding points z₁, z₂, and z₃ are projected onto the simplex 304, by the softmax function, along a ray 306 from the origin “O” through the logits embedding points z₁, z₂, and z₃. Each of the logits embedding points may have a different Cₙₒᵣₘ that normalizes the logits embedding points z₁, z₂, and z₃ by a data point dependent factor, projecting the logits embedding points z₁, z₂, and z₃ to the same output point P, e.g., for z₁ Cₙₒᵣₘ=0.1, for z₂ Cₙₒᵣₘ=1.1, and z₃ Cₙₒᵣₘ=100, while for the output point P Cₙₒᵣₘ=1. Thus, all of the logits embedding points z₁, z₂, and z₃ along the ray 306 are projected onto the simplex 304 at the same output point P, located at where the ray 306 intersects with the simplex 304. The problem introduced by softmax is that farther logits embedding points z₁ and z₃ have similar probability outputs to a close to optimal logits embedding point z₂ on the output space, simplex 304, which is being used a confidence score for the farther logits embedding points z₁ and z₃.

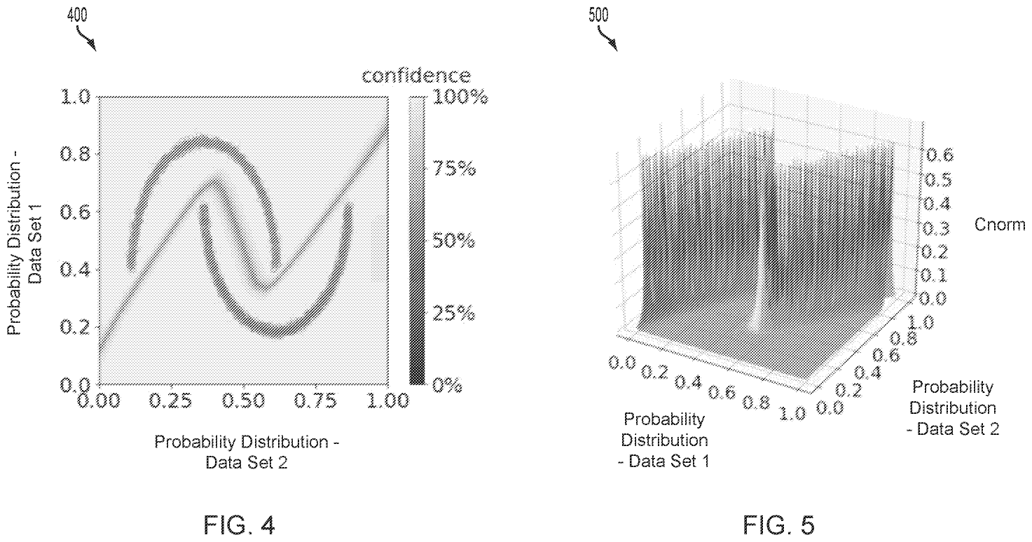

Further, FIG. 4 illustrates an example of softmax confidence mapping, and FIG. 5 illustrates an example of softmax normalization coefficient, Cₙₒᵣₘ, mapping. The graphs 400, 500 further illustrate the aforementioned problems with the softmax function. In these examples, a deep neural network is trained on a two moon dataset. The graph 400 illustrates that the deep neural network, trained with only in-distribution data using softmax, produces high confidence probability outputs for data points that are far off of the training data points. In other words, data that is disparate from the training data, such as data that would not be part of a same class as the training data, may still be indicated as belonging to the class with high confidence by the trained deep neural network. The graph 500 illustrates that softmax normalization coefficients for the data vary over a range of normalization coefficient values. This variation in softmax normalization coefficients allow data that is disparate from the training data, such as data that would not be part of a same class as the training data, may still be indicated as belonging to the class with high confidence by the trained deep neural network.

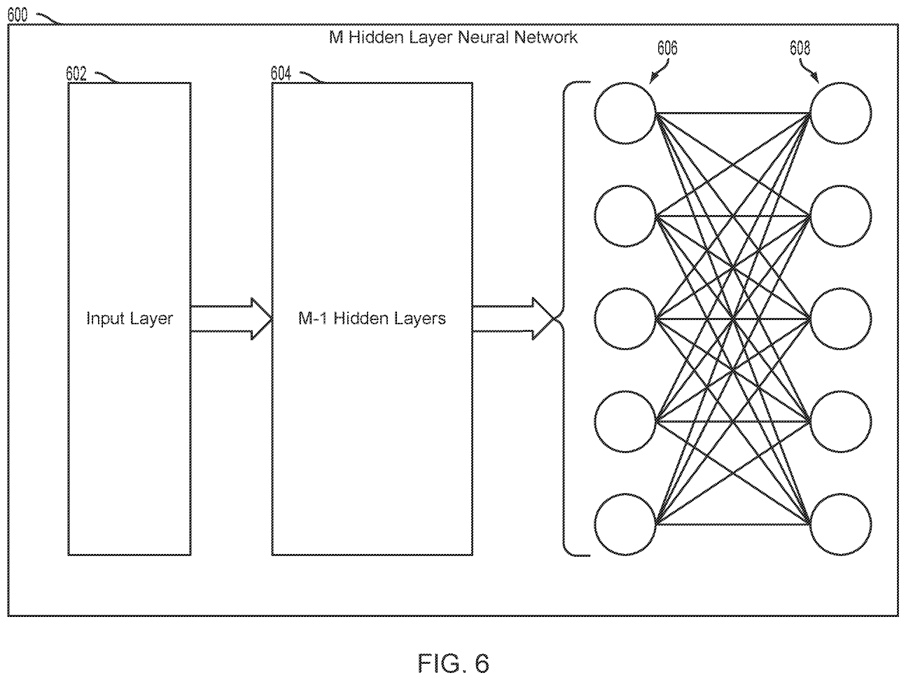

FIG. 6 illustrates an example neural network for implementing an embodiment. With reference to FIGS. 1-5, an M hidden layer neural network 600 may have an input layer 602, any number M hidden layers, including M-1 hidden layers 604, and M^{th} hidden layer 606, and an output layer 608. The M hidden layer neural network 600 may be any type of neural network, including a deep neural network, a convolutional neural network, a multilayer perceptron neural network, a feed forward neural network etc.

The input layer 602 may receive data of an input data set and pass the input Data to a first hidden layer of the M-1 hidden layers 604. The data of the data set may include any type and combination of data, such as image data, video data, audio data, textual data, analog signal data, digital signal data, etc. The M-1 hidden layers 604 may be any type and combination of hidden layers, such as convolutional layers, fully connected layers, sparsely connected layers, etc. The M-1 hidden layer 604 may operate on the input data from the input layer 602 and activation values from earlier hidden layers of the M-1 hidden layer 604 by applying weights, biases, and activation functions to the data received at each of the M-1 hidden layers 604. Similarly, the M^{t}h hidden layer 606 may operate on any the activation values received from the M-1 hidden layers 604.

The nodes having the activation values of the M^{th} hidden layer 606 may be referred to herein as logits, which may represent raw, unbounded prediction values for the given data set. The prediction values may be values representing a probability that the data of the data set may be part of a classification. However, the unbounded values of the logits may be difficult to interpret since there may be no scale to use to determine a degree of the probability associated with each logit. For example, comparison of the logit values to each other may indicate which of the classifications associated with the logit is more or less probable to apply to the data set. However, it may not be possible to determine a degree of overall probability for the classifications associated with the logit being applicable to the data set.

The output layer 608 and the M^{th} hidden layer 606 may have the same number of nodes. The nodes of the output layer 608 may represent classes into which the values of the logits may be classified. The nodes of the output layer 608 may receive the logit values from the logits of the M^{th} hidden layer 606. The output layer 608 may operate on the logit values by applying a batch softmax function, described further herein, to calculate the probabilities of the logit values being classified into each of the classes. The batch softmax function may be dependent on a global normalization factor, Cₙₒᵣₘ^{(global)}, rather than the data point dependent normalization constant, Cₙₒᵣₘ, of traditional softmax. Implementing batch softmax function with Cₙₒᵣₘ^{(global)} rather than the softmax function with Cₙₒᵣₘ may solve the logits embedding ambiguity problem of the softmax function because the batch softmax function is not dependent on a single data point.

The batch softmax function may bound the probability values for the logit values being classified into each of the classes, making the probability values generated but the batch softmax function interpretable within a limited range of probability values. However, unlike traditional softmax, the batch softmax function may not limit the sum of all the probability values to be equal to 1. For example, the batch softmax function may bound the range for each of the probability values between [0, 1], and the sum of all the probability values may be from 0 up to a number of labels, or classifications, of the M hidden layer neural network 600. Therefore, the batch softmax function may model 0-label and N-label classification problems, in addition to the 1-label classification problems that the softmax function may model. The output layer 608 may output the probability values of the logit values being classified into each of the classes.

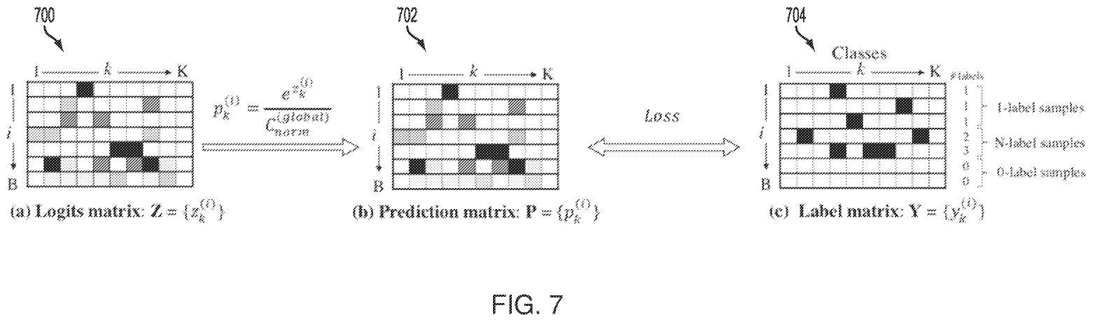

FIG. 7 illustrates an example of batch softmax for implementing an embodiment. With reference to FIGS. 1-6, the batch softmax function may be expressed by the following simplified equation:

$${p}_{k} = \frac{{e}^{{z}_{k}}}{{c}_{n o r m}^{( g l o b a l )}} \qquad ( eq . 3 )$$

wherein the dividend is the same as the dividend of the softmax function (eq. 1), but the divisor is the global normalization factor, Cₙₒᵣₘ^{(global)}, may be a data set dependent, rather than the data point dependent normalization constant, Cₙₒᵣₘ. As compared to the softmax function, the batch softmax function uses Cₙₒᵣₘ^{(global)} for normalization of a whole set of logits of a neural network (e.g., M hidden layer neural network 600 in FIG. 6), rather than an individual Cₙₒᵣₘ for each logits of the neural network.

In an example, a neural network may map an input data x⁽ⁱ⁾ to a K-way output of logits z⁽ⁱ⁾. A batch B of input data x⁽ⁱ⁾ may result in a logits matrix 700, z_{B×K}=[z⁽¹⁾, . . . , z^{(B)}]. In the logits matrix 700, zₖ⁽ⁱ⁾ may be the kth logit of the i^{th} input data of the batch B of input data x⁽ⁱ⁾. Further, the darkness of shading of a logit zₖ⁽ⁱ⁾ may be representative of an activation value of the logit zₖ⁽ⁱ⁾. The batch softmax function may be applied to the logits matrix 700 and map the logits zₖ⁽ⁱ⁾ to prediction values pₖ⁽ⁱ⁾, or probability values, of a prediction matrix P 702, or probability matrix, using Cₙₒᵣₘ^{(global)} The prediction values pₖ⁽ⁱ⁾ may be bound between 0 and 1, and may approximate the probability pₖ⁽ⁱ⁾ of a logit zₖ⁽ⁱ⁾ being classified in a particular class k, i.e., pₖ⁽ⁱ⁾=p(y=k|x⁽ⁱ⁾).

Being that Cₙₒᵣₘ^{(global)} may not be dependent on any particular point of testing or training data of a neural network for normalization of a particular logit, Cₙₒᵣₘ^{(global)} may be estimated from using the logits from the whole batch B of input data x⁽ⁱ⁾. Estimation of Cₙₒᵣₘ^{(global)} may be constrained as follows:

$${\sum }_{i = 1}^{B} {\sum }_{k = 1}^{K} \frac{{e}^{{z}_{k}^{( i )}}}{{C}_{n o r m}} = {\sum }_{i = 1}^{B} {\sum }_{k = 1}^{K} {y}_{k}^{( i )} \qquad ( contraint 1 )$$

$${e}^{{z}_{k}^{( i )}} \leq {C}_{n o r m} \qquad ( contraint 2 )$$

In other words, the sum of all of the predictions in the prediction matrix 702 should be equal to the sum of all of the labels in a ground truth label matrix Y 704. The ground truth label matrix 704 may show where in the batch B of input data x⁽ⁱ⁾ there exist 0-label samples, 1-label samples, and N-label samples. Each shaded label yₖ⁽ⁱ⁾ in the ground truth label matrix 704 may represent a single label, and the number of labels in a row may be added to determine the number of labels for an input data x⁽ⁱ⁾. Further, the value of the exponential of any of the logits in the logits matrix 700 should be less than or equal to the Cₙₒᵣₘ. These constraints may ensure that the value of a probability pₖ⁽ⁱ⁾ may not exceed 1.

From constraint 1, a batch normalization value, Cₙₒᵣₘ^{(batch)}, of the batch B of input data x⁽ⁱ⁾ may be calculated as an estimation of Cₙₒᵣₘ^{(global)}:

$${C}_{n o r m}^{( batch )} ← \frac{1}{n} {\sum }_{i = 1}^{B} {\sum }_{k = 1}^{K} {e}^{{z}_{k}^{( i )}} where n ← {\sum }_{i = 1}^{B} {\sum }_{k = 1}^{K} {y}_{k}^{( i )} \qquad ( eq . 4 )$$

The ground truth label matrix Y 704 may be used for training the neural network using the batch softmax function. A loss function, such as cross entropy loss, Negative log-likelihood (NLL) loss, or the like, may be calculated between the prediction matrix 702 and the ground truth label matrix 704 for training the neural network using the batch softmax function. Constraint 2 may not be enforced as part of the batch softmax function for normalization of the logits z⁽ⁱ⁾. Rather, constraint 2 may be a loss term enforced during training of the neural network.

The batch softmax function may be used for normalization of the logits z⁽ⁱ⁾ and for determining the loss for training the neural network. A batch of logits Z=[z⁽¹⁾, . . . , z^{(B)}] and a batch of labels Y=[y⁽¹⁾, . . . , y^{(B)}] may be known prior to applying the batch softmax function. The logits z⁽ⁱ⁾ may be preprocessed for numeric stability, for example, by removing some maximum logits z⁽ⁱ⁾:

$${C}_{safe} ← max ( \{ {z}_{k}^{( i )} \} ) \qquad ( eq . 5 )$$

$${z}_{k}^{{( i )}^{′}} ← {z}_{k}^{( i )} - {C}_{safe} \qquad ( eq . 6 )$$

Removing the maximum logits may make floating point computation less likely to overflow.

The total number of labels y⁽ⁱ⁾ in the batch of labels Y may be counted:

$$n ← {\sum }_{i = 1}^{B} {\sum }_{k = 1}^{K} {y}_{k}^{{( i )}^{′}} \qquad ( eq . 7 )$$

For each batch of logits Z and labels Y, Cₙₒᵣₘ^{(global)} may be estimated using Cₙₒᵣₘ^{(batch)}:

$${c}_{n o r m}^{( batch )} ← \frac{1}{n} {\sum }_{i = 1}^{B} {\sum }_{k = 1}^{K} {e}^{{z}_{k}^{{( i )}^{′}}} \qquad ( eq . 8 )$$

Using Cₙₒᵣₘ^{(batch)}, terms for the loss function may be calculated, including a logarithmic value of each probability:

$$log {p}_{i} ← {z}_{k}^{{( i )}^{′}} - log {C}_{n o r m}^{( batch )} \qquad ( eq . 9 )$$

The terms for the loss function may be used to compute the loss in a loss function, such as NLL loss:

$$L ← \frac{1}{B} {\sum }_{i = 1}^{B} {\sum }_{k = 1}^{K} max ( log {p}_{i} , 0 ) - {y}_{i} \cdot log {p}_{i} \qquad ( eq . 10 )$$

where a normal NLL loss term (yᵢ·log pᵢ) is subtracted from the loss term to enforce constraint 2 (max(log pᵢ, 0)). The NLL loss L may generate a gradient:

$${∇}_{{z}_{k}} L = {p}_{i} - {y}_{i} \qquad ( eq . 11 )$$

This gradient is almost the same as the softmax function, which may indicate that the gradient of the batch softmax function is as stable as the softmax function. The difference may be that the softmax function will always have zero gradient for 0-label problem, causing the neural network to stop training. The gradient of the batch softmax function may remove this restriction and the gradient may stay as the same form, regardless of 0-label, 1-label, and N-label problems.

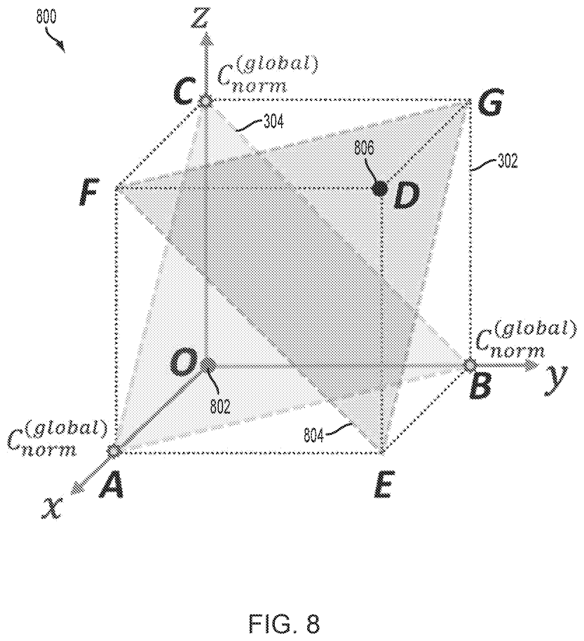

FIG. 8 illustrates an example of batch softmax for implementing an embodiment. With reference to FIGS. 1-7, the batch softmax function (eq. 3) may be used to approximate a categorical distribution of a neural network. The batch softmax function may apply the exponential function and L1 normalization to logits of a neural network (e.g., M hidden layer neural network 600 in FIG. 6) using Cₙₒᵣₘ^{(global)}, which results in a probability vector P=[p₀, . . . , pₙ] representing a probability of each of the classes applying to each of the logits, i.e., pₖ=p(y=k|x).

The graph 800 illustrates N+1 manifolds 304, 802, 804, 806, in the Euclidian space 302, which may include an origin point manifold 802, the simplex 304 as a manifold 304, another simplex manifold 804, and a point manifold 806 opposite the origin point manifold in the Euclidian space 302. In contrast to softmax, for which multiple distinct logits may be projected at the same output point, as softmax may only accurately model a 1-label classification problem, batch softmax may be used to project distinct logits to the N+1 manifolds 304, 802, 804, 806 for up to an N-label classification problem. In further contrast to softmax, rather than Cₙₒᵣₘ representing a normalization factor for a single point on the simplex manifold 304, batch softmax may use Cₙₒᵣₘ^{(global)} representing a normalization factor for the entire simplex manifold 304.

Batch softmax may be used to project a logit to a manifold 304, 802, 804, 806 based on the number of labels to which the logit may be classified. Batch softmax and the NLL loss function may be used to train a neural network to produce logit values that may correlate the number of labels to which the logit may be classified to a manifold 304, 802, 804, 806 for that number of labels. As compared to softmax, the correlation of a number of labels to which the logit may be classified and a manifold 304, 802, 804, 806 for that number of labels may reduce the ambiguity caused by softmax projecting out-of-distribution data to the simplex manifold 304. By projecting the logits to manifolds 304, 802, 804, 806 closer to their coordinates in the Euclidian space 302, batch softmax provides a more accurate representation of a probability that the logits are classified to a particular label.

For example, in the 3-label problem modeled in the graph 800, a point P (not shown) having coordinates (pₓ, p_{y}, p_{z}) in the Euclidian space 302 may represent a probability for up to 3 classes. Using batch softmax, during training of the neural network, the point P may be projected to a manifold 304, 802, 804, 806 based on the probability that the point P may be classified to a number of labels associated with the manifold 304, 802, 804, 806. The probability may be represented by a distance of the point P to the manifold 304, 802, 804, 806. The neural network may be trained to enforce constraints on the location of point P in later iterations so that the point P may be increasingly more accurately located at or near the appropriate manifold 304, 802, 804, 806. Such constraints may include for example:

| Label | Manifold | Constraint |
|---|---|---|
| 0-label | O | pₓ + p_{y} + p_{z} = 0 and pₓ, p_{y}, p_{z} ∈ [0, 1] |
| 1-label | ABC | pₓ + p_{y} + p_{z} = 1 and pₓ, p_{y}, p_{z} ∈ [0, 1] |
| 2-label | EFG | pₓ + p_{y} + p_{z} = 2 and pₓ, p_{y}, p_{z} ∈ [0, 1] |
| 3-label | D | pₓ + p_{y} + p_{z} = 3 and pₓ, p_{y}, p_{z} ∈ [0, 1] |

Whereas during training of the neural network, the point P may be increasingly more accurately located at or near the appropriate manifold 304, 802, 804, 806, during testing and application of the neural network, the point P may be located anywhere within the Euclidian space 302.

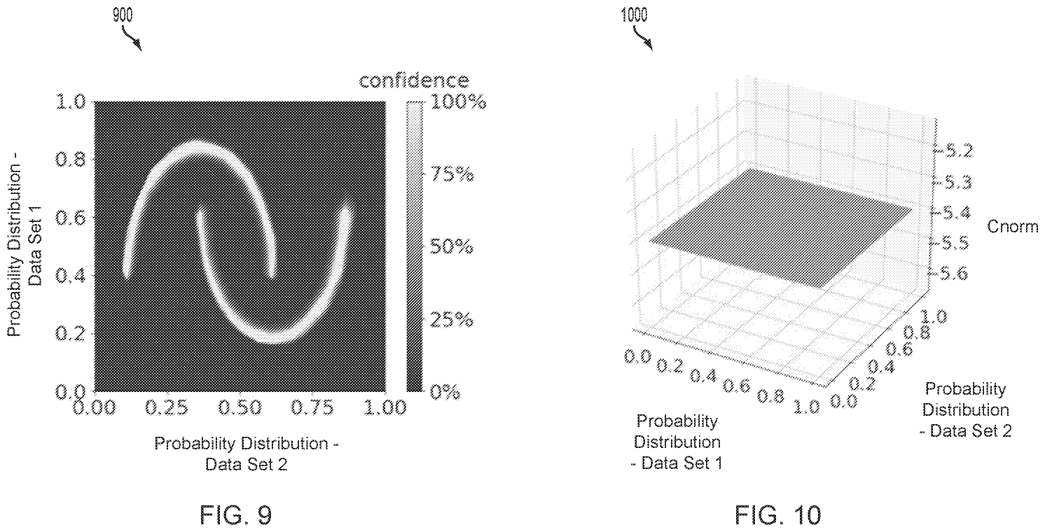

Further, FIG. 9 illustrates an example of batch softmax confidence mapping for implementing an embodiment, and FIG. 10 illustrates an example of batch softmax normalization factor, Cₙₒᵣₘ^{(global)}, mapping for implementing an embodiment. The graphs 900, 1000 further illustrate the benefits of the batch softmax function. In these examples, a deep neural network is trained on a two moon dataset.

The graph 900 illustrates that the deep neural network, trained with only in-distribution data using batch softmax, produces high confidence probability outputs for data points that are close to the training data points, and low confidence probability outputs for data points that are far off of the training data points. In other words, data that is disparate from the training data, such as data that would not be part of a same class as the training data, may be less likely to be indicated as belonging to the class by the trained deep neural network than when using softmax (see graph 400 in FIG. 4).

The graph 1000 illustrates that batch softmax normalization factors for the data are constant. These constant batch softmax normalization factors allow recognition of data that is disparate from the training data, such as data that would not be part of a same class as the training data, and appropriately provide a low confidence score by the trained deep neural network that the disparate data may be classified by a certain label.

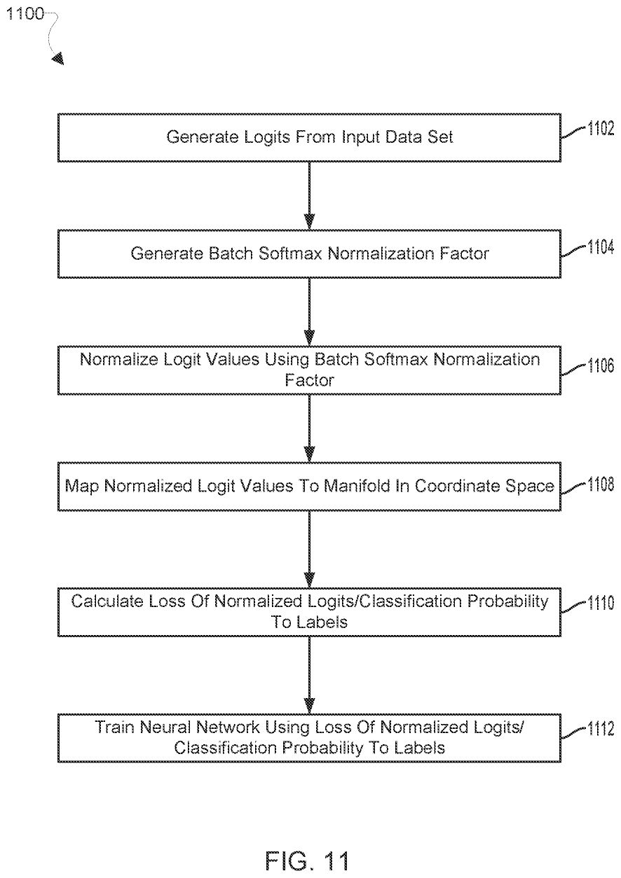

FIG. 11 illustrates a method 1100 for implementing a batch softmax normalization function according to some embodiments. The method 1100 may be implemented in a computing device in software executing in a processor (e.g., the processor 14 in FIGS. 1 and 2 and processor cores 200, 201, 202, 203 in FIG. 2), in general purpose hardware, in dedicated hardware, or in a combination of a software-configured processor and dedicated hardware, such as a processor executing software for a neural network (e.g., M hidden layer neural network 600 in FIG. 6) that includes other individual components. In order to encompass the alternative configurations enabled in the various embodiments, the hardware implementing the method 1100 is referred to herein as a “processing device.”

In block 1102, the processing device may generate logits from an input data set. For example, the input data set may result in a logits matrix (e.g., logits matrix 700 in FIG. 7). Input data from the input data set may be provided to an input layer (e.g., input layer 602 in FIG. 6) of a neural network, processed through any number of hidden layers (e.g., M-1 hidden layers 604 in FIG. 6), and output as logits at a final hidden layer (e.g., M^{th} hidden layer 606 in FIG. 6).

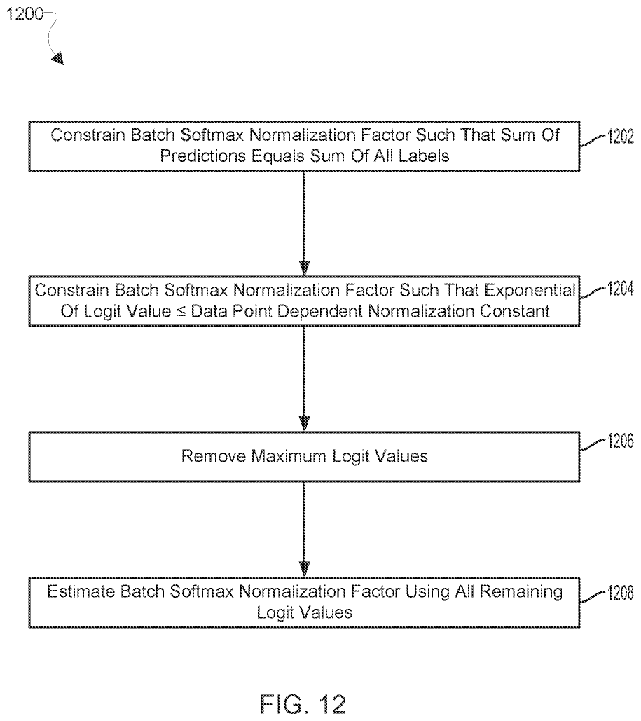

In block 1104, the processing device may generate a batch softmax normalization factor. Generating the batch softmax normalization factor is described further herein in the method 12 with reference to FIG. 12. The batch softmax normalization factor may also be referred to herein as a global normalization factor, Cₙₒᵣₘ^{(global)}.

In block 1106, the processing device may normalize logit values using batch softmax normalization factor. For example, the batch softmax function may be applied to the logits matrix and map the logits to prediction values, or probability values, of a prediction matrix (e.g., prediction matrix 702 in FIG. 7), or probability matrix, using Cₙₒᵣₘ^{(global)}. The processing device may implement L1 normalization of the logit values using the batch softmax normalization factor as a divisor and the logit values as dividends.

In block 1108, the processing device may map the normalized logit values to manifolds (e.g., manifolds 304, 802, 804, 806 in FIG. 8) in a coordinate space (e.g., Euclidian space 302 in FIG. 8). The processing device may map the normalized logit values based on which manifold, corresponding to a number of labels, to which the normalized logit values are most closely located in the coordinate space. The normalized logit values may represent a probability that the logit may be classified as any of the labels associated with the coordinate space. The closer a normalized logit is located to a manifold, the more likely the logit may be classified by as many labels as the manifold corresponds to.

In block 1110, the processing device may calculate a loss of the normalized logit values to labels for the logits. Each logit may be actually classified to specific labels. For example, a ground truth label matrix (e.g., ground truth label matrix 704 in FIG. 7) may show where in the input data set there exist different label samples, such as 0-label samples, 1-label samples, and N-label samples The number of labels to which a logic is actually classified may deviate from the number of labels the normalized value of the logit represents as a probability that the logit is classified to. This deviation may result from inaccurate identification and classification of the input data by the neural network. In some embodiments, a loss function, such as cross entropy loss, Negative log-likelihood (NLL) loss, or the like, may be calculated between the prediction matrix and the ground truth label matrix for training the neural network using the batch softmax function. The loss may be calculated as described herein with reference to equations 9 and 10.

In block 1112, the processing device may train the neural network using the loss of the normalized logit values to labels for the logits. The processing device may use the loss values to train the neural network, such as through gradient decent or the like. The processing device may update values, such as weights, of the neural network based on the loss values to reduce the loss values on successive implementations of the neural network.

FIG. 12 illustrates a method 1100 for generating a batch softmax normalization factor according to some embodiments. The method 1200 may be implemented in a computing device in software executing in a processor (e.g., the processor 14 in FIGS. 1 and 2 and processor cores 200, 201, 202, 203 in FIG. 2), in general purpose hardware, in dedicated hardware, or in a combination of a software-configured processor and dedicated hardware, such as a processor executing software for a neural network (e.g., M hidden layer neural network 600 in FIG. 6) that includes other individual components. In order to encompass the alternative configurations enabled in the various embodiments, the hardware implementing the method 1200 is referred to herein as a “processing device.” In some embodiments, the method 1200 may be implemented as part of a block 1104 of the method 1100 described herein with reference to FIG. 11.

In block 1202, the processing device may constrain a batch softmax normalization factor such that a sum of prediction values resulting from the normalization of logit values using data point dependent normalization constants equals a sum of all labels for the logit values (see constraint 1). Logit values may be actually classified to any number of labels, regardless of whether a neural network successfully classifies the logit values to the correct labels. To generate a batch softmax normalization factor for all of the logits resulting from an implementation of the neural network, the sum of the prediction or probability values, which result from normalization of the logit values, may equal the sum of the number of the labels to which the logit values are actually classified. For example, the sum of all of the predictions in a prediction matrix (e.g., prediction matrix 702 in FIG. 7) should be equal to the sum of all of the labels in a ground truth label matrix (e.g., ground truth label matrix 704 in FIG. 7).

In block 1204, the processing device may constrain the batch softmax normalization factor such that an exponential function of any logit value is less than or equal to a data point dependent normalization constant (see constraint 2). This constraint may be used as a loss term and enforced during training of the neural network.

In block 1206, the processing device may remove maximum logit values (see eqs. 5 and 6). To improve numeric stability, the maximum logit values may be removed from a set of logit values used to generate the batch softmax normalization factor. Removing the maximum logits may make floating point computation less likely to overflow.

In block 1208, the processing device may estimate the batch softmax normalization factor using all the remaining logit values (see eqs. 4, 7, and 8). The processing device may count a number of labels within a batch of labels for an implementation of the neural network for an input data set. The processing device may sum the exponential function values for each of the remaining logits resulting from the implementation of the neural network and not removed in block 1206. These remaining logit values may be referred to as a batch of logit values. The processing device may divide the sum of the exponential function values of the remaining logits by the number of labels.

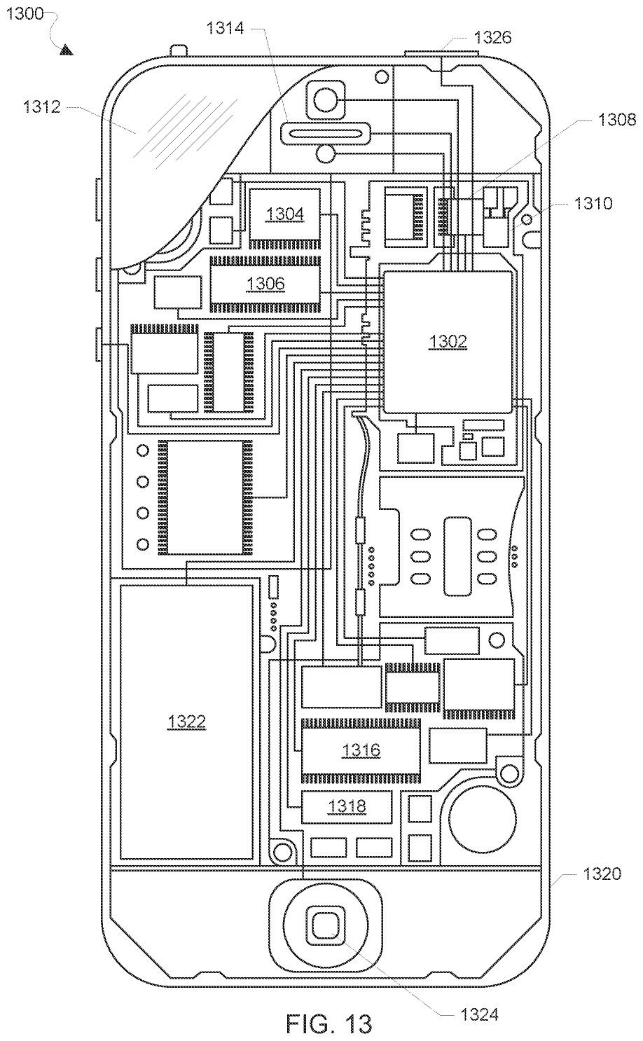

The various embodiments (including, but not limited to, embodiments described above with reference to FIGS. 1-12) may be implemented in a wide variety of computing systems including mobile computing devices, an example of which suitable for use with the various embodiments is illustrated in FIG. 13. The mobile computing device 1300 may include a processor 1302 coupled to a touchscreen controller 1304 and an internal memory 1306. The processor 1302 may be one or more multicore integrated circuits designated for general or specific processing tasks. The internal memory 1306 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1304 and the processor 1302 may also be coupled to a touchscreen panel 1312, such as a resistive-sensing touchscreen, capacitive-sensing touchscreen, infrared sensing touchscreen, etc. Additionally, the display of the computing device 1300 need not have touch screen capability.

The mobile computing device 1300 may have one or more radio signal transceivers 1308 (e.g., Peanut, Bluetooth, ZigBee, Wi-Fi, RF radio) and antennae 1310, for sending and receiving communications, coupled to each other and/or to the processor 1302. The transceivers 1308 and antennae 1310 may be used with the above-mentioned circuitry to implement the various wireless transmission protocol stacks and interfaces. The mobile computing device 1300 may include a cellular network wireless modem chip 1316 that enables communication via a cellular network and is coupled to the processor.

The mobile computing device 1300 may include a peripheral device connection interface 1318 coupled to the processor 1302. The peripheral device connection interface 1318 may be singularly configured to accept one type of connection, or may be configured to accept various types of physical and communication connections, common or proprietary, such as Universal Serial Bus (USB), FireWire, Thunderbolt, or PCIe. The peripheral device connection interface 1318 may also be coupled to a similarly configured peripheral device connection port (not shown).

The mobile computing device 1300 may also include speakers 1314 for providing audio outputs. The mobile computing device 1300 may also include a housing 1320, constructed of a plastic, metal, or a combination of materials, for containing all or some of the components described herein. The mobile computing device 1300 may include a power source 1322 coupled to the processor 1302, such as a disposable or rechargeable battery. The rechargeable battery may also be coupled to the peripheral device connection port to receive a charging current from a source external to the mobile computing device 1300. The mobile computing device 1300 may also include a physical button 1324 for receiving user inputs. The mobile computing device 1300 may also include a power button 1326 for turning the mobile computing device 1300 on and off.

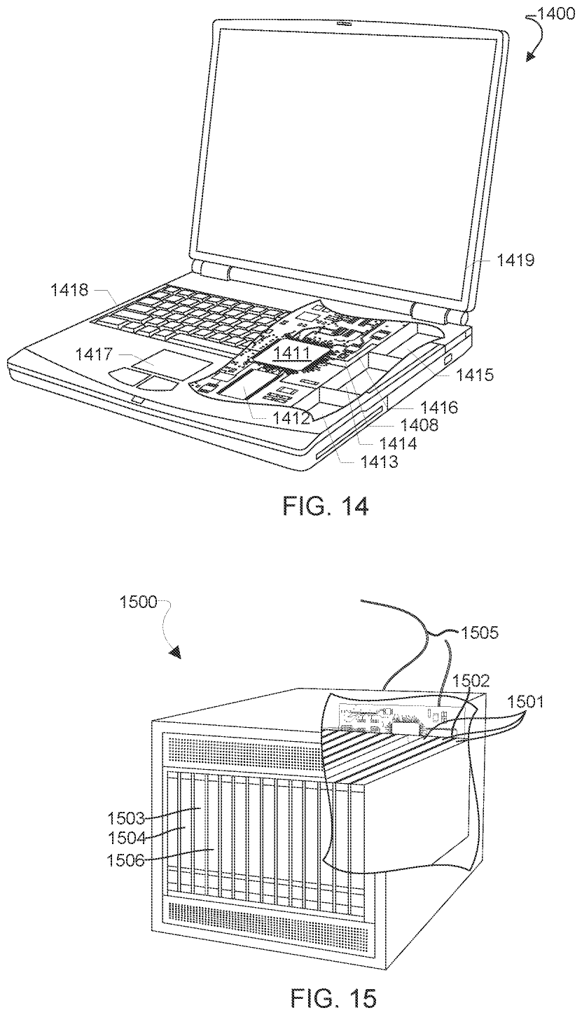

The various embodiments (including, but not limited to, embodiments described above with reference to FIGS. 1-12) may be implemented in a wide variety of computing systems include a laptop computer 1400 an example of which is illustrated in FIG. 14. Many laptop computers include a touchpad touch surface 1417 that serves as the computer's pointing device, and thus may receive drag, scroll, and flick gestures similar to those implemented on computing devices equipped with a touch screen display and described above. A laptop computer 1400 will typically include a processor 1411 coupled to volatile memory 1412 and a large capacity nonvolatile memory, such as a disk drive 1413 of Flash memory. Additionally, the computer 1400 may have one or more antenna 1408 for sending and receiving electromagnetic radiation that may be connected to a wireless data link and/or cellular telephone transceiver 1416 coupled to the processor 1411. The computer 1400 may also include a floppy disc drive 1414 and a compact disc (CD) drive 1415 coupled to the processor 1411. In a notebook configuration, the computer housing includes the touchpad 1417, the keyboard 1418, and the display 1419 all coupled to the processor 1411. Other configurations of the computing device may include a computer mouse or trackball coupled to the processor (e.g., via a USB input) as are well known, which may also be used in conjunction with the various embodiments.

The various embodiments (including, but not limited to, embodiments described above with reference to FIGS. 1-12) may also be implemented in fixed computing systems, such as any of a variety of commercially available servers. An example server 1500 is illustrated in FIG. 15. Such a server 1500 typically includes one or more multicore processor assemblies 1501 coupled to volatile memory 1502 and a large capacity nonvolatile memory, such as a disk drive 1504. As illustrated in FIG. 15, multicore processor assemblies 1501 may be added to the server 1500 by inserting them into the racks of the assembly. The server 1500 may also include a floppy disc drive, compact disc (CD) or digital versatile disc (DVD) disc drive 1506 coupled to the processor 1501. The server 1500 may also include network access ports 1503 coupled to the multicore processor assemblies 1501 for establishing network interface connections with a network 1505, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Implementation examples are described in the following paragraphs. While some of the following implementation examples are described in terms of example methods, further example implementations may include: the example methods discussed in the following paragraphs implemented by a computing device comprising a processor configured with processor-executable instructions to perform operations of the example methods; the example methods discussed in the following paragraphs implemented by a computing device including means for performing functions of the example methods; and the example methods discussed in the following paragraphs implemented as a non-transitory processor-readable storage medium having stored thereon processor-executable instructions configured to cause a processor of a computing device to perform the operations of the example methods.

Example 1. A method, including: generating a batch softmax normalization factor using a plurality of logit values from a plurality of logits of a layer of a neural network, normalizing the plurality of logit values using the batch softmax normalization factor, and mapping each of the normalized plurality of logit values to one of a plurality of manifolds in a coordinate space, wherein each of the plurality of manifolds represents a number of labels to which a logit can be classified, and wherein at least one of the plurality of manifolds represents a number of labels other than one label.

Example 2. The method of example 1, further including calculating a loss value of the normalized plurality of logit values compared to a ground truth number of labels to which the logits are classified.

Example 3. The method of example 2, further including training the neural network using the loss value to generate logits that are mapped to an appropriate manifold in the coordinate space prior to normalization of the logits, wherein the logits are mapped based on the number of labels to which the logit can be classified.

Example 4. The method of any of examples 1-3, in which generating the batch softmax normalization factor may include constraining the batch softmax normalization factor such that a sum of prediction values resulting from normalizing the plurality of logit values using data point dependent normalization constants equals a sum of all labels for the plurality of logit values.

Example 5. The method of any of examples 1-3, in which generating the batch softmax normalization factor may include identifying maximum logit values for the plurality of logits, and removing the maximum logit values, wherein the plurality of logit values comprises logit values remaining after removing the maximum logit values.

Example 6. The method of any of examples 1-3, in which generating the batch softmax normalization factor may include constraining the batch softmax normalization factor such that an exponential function of any logit value of the plurality of logit values is less than or equal to a data point dependent normalization constants.

Example 7. The method of any of examples 1-6, in which the plurality of manifolds may include N+1 manifolds for N labels, in which a first manifold of the plurality of manifolds represents zero labels, a second manifold of the plurality of manifolds represents one label, and a third manifold of the plurality of manifolds represents N labels.

Example 8. The method of example 7, in which the first manifold is an origin point of the coordinate space, the second manifold is a simplex in the coordinate space, the third manifold is a point of the coordinate space opposite the origin point, and generating the batch softmax normalization factor using the plurality of logit values from the plurality of logits of the layer of the neural network may include generating the batch softmax normalization factor using the plurality of logit values from the plurality of logits of a last hidden layer of the neural network.

Computer program code or “program code” for execution on a programmable processor for carrying out operations of the various embodiments may be written in a high level programming language such as C, C++, C #, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method, comprising:
generating a batch softmax normalization factor using a plurality of logit values from a plurality of logits of a layer of a neural network;
normalizing the plurality of logit values using the batch softmax normalization factor; and
mapping each of the normalized plurality of logit values to one of a plurality of manifolds in a coordinate space, wherein each of the plurality of manifolds represents a number of labels to which a logit can be classified, and wherein at least one of the plurality of manifolds represents a number of labels other than one label.

2. The method of claim 1, further comprising calculating a loss value of the normalized plurality of logit values compared to a ground truth number of labels to which the logits are classified.

3. The method of claim 2, further comprising training the neural network using the loss value to generate logits that are mapped to an appropriate manifold in the coordinate space prior to normalization of the logits, wherein the logits are mapped based on the number of labels to which the logit can be classified.

4. The method of claim 1, wherein generating the batch softmax normalization factor comprises constraining the batch softmax normalization factor such that a sum of prediction values resulting from normalizing the plurality of logit values using data point dependent normalization constants equals a sum of all labels for the plurality of logit values.

5. The method of claim 1, wherein generating the batch softmax normalization factor comprises:
identifying maximum logit values for the plurality of logits; and
removing the maximum logit values, wherein the plurality of logit values comprises logit values remaining after removing the maximum logit values.

6. The method of claim 1, wherein generating the batch softmax normalization factor comprises constraining the batch softmax normalization factor such that an exponential function of any logit value of the plurality of logit values is less than or equal to a data point dependent normalization constants.

7. The method of claim 1, wherein the plurality of manifolds comprises N+1 manifolds for N labels, wherein a first manifold of the plurality of manifolds represents zero labels, a second manifold of the plurality of manifolds represents one label, and a third manifold of the plurality of manifolds represents N labels.

8. The method of claim 7, wherein:
the first manifold is an origin point of the coordinate space;
the second manifold is a simplex in the coordinate space;
the third manifold is a point of the coordinate space opposite the origin point; and
generating the batch softmax normalization factor using the plurality of logit values from the plurality of logits of the layer of the neural network comprises generating the batch softmax normalization factor using the plurality of logit values from the plurality of logits of a last hidden layer of the neural network.

9. A computing device, comprising a processor configured with processor-executable instructions to perform operations comprising:
generating a batch softmax normalization factor using a plurality of logit values from a plurality of logits of a layer of a neural network;
normalizing the plurality of logit values using the batch softmax normalization factor; and
mapping each of the normalized plurality of logit values to one of a plurality of manifolds in a coordinate space, wherein each of the plurality of manifolds represents a number of labels to which a logit can be classified, and wherein at least one of the plurality of manifolds represents a number of labels other than one label.

10. The computing device of claim 9, wherein the processor is configured with processor-executable instructions to perform operations further comprising calculating a loss value of the normalized plurality of logit values compared to a ground truth number of labels to which the logits are classified.

11. The computing device of claim 10, wherein the processor is configured with processor-executable instructions to perform operations further comprising training the neural network using the loss value to generate logits that are mapped to an appropriate manifold in the coordinate space prior to normalization of the logits, wherein the logits are mapped based on the number of labels to which the logit can be classified.

12. The computing device of claim 9, wherein the processor is configured with processor-executable instructions to perform operations such that generating the batch softmax normalization factor comprises constraining the batch softmax normalization factor such that a sum of prediction values resulting from normalizing the plurality of logit values using data point dependent normalization constants equals a sum of all labels for the plurality of logit values.

13. The computing device of claim 9, wherein the processor is configured with processor-executable instructions to perform operations such that generating the batch softmax normalization factor comprises:
identifying maximum logit values for the plurality of logits; and
removing the maximum logit values, wherein the plurality of logit values comprises logit values remaining after removing the maximum logit values.

14. The computing device of claim 9, wherein the processor is configured with processor-executable instructions to perform operations such that generating the batch softmax normalization factor comprises constraining the batch softmax normalization factor such that an exponential function of any logit value of the plurality of logit values is less than or equal to a data point dependent normalization constant.

15. The computing device of claim 9, wherein the plurality of manifolds comprises N+1 manifolds for N labels, wherein a first manifold of the plurality of manifolds represents zero labels, a second manifold of the plurality of manifolds represents one label, and a third manifold of the plurality of manifolds represents N labels.

16. The computing device of claim 15, wherein:
the first manifold is an origin point of the coordinate space;
the second manifold is a simplex in the coordinate space;
the third manifold is a point of the coordinate space opposite the origin point; and
the processor is configured with processor-executable instructions to perform operations such that generating the batch softmax normalization factor using the plurality of logit values from the plurality of logits of the layer of the neural network comprises generating the batch softmax normalization factor using the plurality of logit values from the plurality of logits of a last hidden layer of the neural network.

17. A computing device, comprising:
means for generating a batch softmax normalization factor using a plurality of logit values from a plurality of logits of a layer of a neural network;
means for normalizing the plurality of logit values using the batch softmax normalization factor; and
means for mapping each of the normalized plurality of logit values to one of a plurality of manifolds in a coordinate space, wherein each of the plurality of manifolds represents a number of labels to which a logit can be classified, and wherein at least one of the plurality of manifolds represents a number of labels other than one label.

18. The computing device of claim 17, further comprising means for calculating a loss value of the normalized plurality of logit values compared to a ground truth number of labels to which the logits are classified.

19. The computing device of claim 18, further comprising means for training the neural network using the loss value to generate logits that are mapped to an appropriate manifold in the coordinate space prior to normalization of the logits, wherein the logits are mapped based on the number of labels to which the logit can be classified.

20. The computing device of claim 17, wherein means for generating the batch softmax normalization factor comprises means for constraining the batch softmax normalization factor such that a sum of prediction values resulting from normalizing the plurality of logit values using data point dependent normalization constants equals a sum of all labels for the plurality of logit values.

21. The computing device of claim 17, wherein means for generating the batch softmax normalization factor comprises:
means for identifying maximum logit values for the plurality of logits; and
means for removing the maximum logit values, wherein the plurality of logit values comprises logit values remaining after removing the maximum logit values.

22. The computing device of claim 17, wherein means for generating the batch softmax normalization factor comprises means for constraining the batch softmax normalization factor such that an exponential function of any logit value of the plurality of logit values is less than or equal to a data point dependent normalization constants.

23. The computing device of claim 17, wherein the plurality of manifolds comprises N+1 manifolds for N labels, wherein a first manifold of the plurality of manifolds represents zero labels, a second manifold of the plurality of manifolds represents one label, and a third manifold of the plurality of manifolds represents N labels.

24. The computing device of claim 23, wherein:
the first manifold is an origin point of the coordinate space;
the second manifold is a simplex in the coordinate space;
the third manifold is a point of the coordinate space opposite the origin point; and
means for generating the batch softmax normalization factor using the plurality of logit values from the plurality of logits of the layer of the neural network comprises means for generating the batch softmax normalization factor using the plurality of logit values from the plurality of logits of a last hidden layer of the neural network.

25. A non-transitory, processor-readable medium having stored thereon processor-executable instructions configured to cause a processor to perform operations comprising:
generating a batch softmax normalization factor using a plurality of logit values from a plurality of logits of a last hidden layer of a neural network;
normalizing the plurality of logit values using the batch softmax normalization factor; and
mapping each of the normalized plurality of logit values to one of a plurality of manifolds in a coordinate space, wherein each of the plurality of manifolds represents a number of labels to which a logit can be classified, and wherein at least one of the plurality of manifolds represents a number of labels other than one label.

26. The non-transitory, processor-readable medium of claim 25, wherein the stored processor-executable instructions are configured to cause the processor to perform operations further comprising calculating a loss value of the normalized plurality of logit values compared to a ground truth number of labels to which the logits are classified.

27. The non-transitory, processor-readable medium of claim 26, wherein the stored processor-executable instructions are configured to cause the processor to perform operations further comprising training the neural network using the loss value to generate logits that are mapped to an appropriate manifold in the coordinate space prior to normalization of the logits, wherein the logits are mapped based on the number of labels to which the logit can be classified.

28. The non-transitory, processor-readable medium of claim 25, wherein the stored processor-executable instructions are configured to cause the processor to perform operations such that generating the batch softmax normalization factor comprises constraining the batch softmax normalization factor such that a sum of prediction values resulting from normalizing the plurality of logit values using data point dependent normalization constants equals a sum of all labels for the plurality of logit values.

29. The non-transitory, processor-readable medium of claim 25, wherein the stored processor-executable instructions are configured to cause the processor to perform operations such that generating the batch softmax normalization factor comprises:
identifying maximum logit values for the plurality of logits; and
removing the maximum logit values, wherein the plurality of logit values comprises logit values remaining after removing the maximum logit values.

30. The non-transitory, processor-readable medium of claim 25, wherein the stored processor-executable instructions are configured to cause the processor to perform operations such that generating the batch softmax normalization factor comprises constraining the batch softmax normalization factor such that an exponential function of any logit value of the plurality of logit values is less than or equal to a data point dependent normalization constants.

31. The non-transitory, processor-readable medium of claim 25, wherein the plurality of manifolds comprises N+1 manifolds for N labels, wherein a first manifold of the plurality of manifolds represents zero labels, a second manifold of the plurality of manifolds represents one label, and a third manifold of the plurality of manifolds represents N labels.

32. The non-transitory, processor-readable medium of claim 31, wherein:
the first manifold is an origin point of the coordinate space;
the second manifold is a simplex in the coordinate space;
the third manifold is a point of the coordinate space opposite the origin point; and
the stored processor-executable instructions are configured to cause the processor to perform operations such that generating the batch softmax normalization factor using the plurality of logit values from the plurality of logits of the layer of the neural network comprises generating the batch softmax normalization factor using the plurality of logit values from the plurality of logits of a last hidden layer of the neural network.
